(19) United States
(12) Patent Application Publication
(10) Pub. No.: US 2002/0005924 A1
(43) Pub. Date: Jan. 17, 2002

(54) Light diffusion sheet

(75) Inventor: Yoshihisa Kimura, Saitama-shi (JP)

Correspondence Address: LORUSSO & LOUD, 3137 Mt. Vernon Avenue, Alexandria, VA, 22305, US

(73) Assignee: KIMOTO CO., LTD.

(21) Appl. No.: 09/854,602

(22) Filed: May 15, 2001

(30) Foreign Application Priority Data
May 16, 2000 (JP) 2000-143464

(51) Int. Cl. G02F 1/1335

(52) U.S. Cl. 349/112

(57) ABSTRACT

There is provided a light diffusion sheet comprising a light diffusion layer formed on a transparent substrate and containing a binder resin and resin particles that impart an uneven surface, wherein the resin particles are substantially spherical and have a mean particle diameter of 16.0-30.0 μm and a coefficient of variation of particle diameter distribution of less than 50.0%. The light diffusion sheet is high luminance in the front direction, is excellent in light-diffusing property, does not require use of an expensive prism sheet which, is readily susceptible to surface damage, and does not require careful handling.

### FIELD OF THE INVENTION

The present invention relates to a light diffusion sheet, in particular, a light diffusion sheet suitable for use in backlight units of liquid crystal displays.

### BACKGROUND OF THE INVENTION

As light diffusion sheets used for backlight units of liquid crystal displays, there are conventionally used transparent plastic films applied on one surface with a transparent resin solution containing inorganic particles or resin particles dispersed therein.

Performance features required by such light diffusion sheets include invisibility of light diffusion patterns in the light conductive plates, high luminance in the front direction and so forth.

To realize these features, improvements have been made by selecting the type and content of the resin and light diffusion particles used in the light diffusion layers. However, the enhancement of luminance in the front direction that can be achieved by such improvements is limited. Therefore, attempts have been made to direct light in the peripheral direction toward the front direction by means of a prism sheet. Since such a prism sheet does not have light-diffusing ability, the practice has been to superimpose it on a conventional light diffusion sheet. Japanese Patent Unexamined Publication (Kokai) Nos. 9-127314and 9-197109, for example, disclose light diffusion sheets which, being combined with a lens sheet called a prism sheet, provides enhanced luminance in the front direction compared with conventional light diffusion sheets, together with adequate light-diffusing property.

Such light diffusion sheets as disclosed in Japanese Patent Unexamined Publication (Kokai) Nos. 9-127314 and 9-197109 aim at obtaining high luminance and excellent light diffusion by using a prism sheet. However, such a prism sheet has drawbacks. For example, it is expensive and it is susceptible to surface damage, making it difficult to handle. From the viewpoint of cost performance, therefore, a strong need has recently come to be felt for a light diffusion sheet that can realize high luminance and excellent light diffusion without using such a prism sheet.

Moreover, the uneven surfaces of the light diffusion layers of conventional light diffusion sheets are susceptible to damage during handling. Use of damaged light diffusion sheets in today's high-precision liquid crystal displays is unacceptable because even slight damage to the light diffusion sheet can result in a defective liquid crystal display. Therefore, when the backlight units of liquid crystal displays are produced using these light diffusion sheets, they must be handled with extreme care, and productivity is degraded in proportion.

Accordingly, an object of the present invention is to provide a light diffusion sheet that is high luminance in the front direction, is excellent in light-diffusing property, does not require use of an expensive prism sheet which, is readily susceptible to surface damage, and does not require careful handling. Another object of the present invention is to provide a light diffusion sheet whose light diffusion layer has an uneven surface that is resistant to damage. A further object of the present invention it to provide a light diffusion sheet that is not susceptible to damage when used in a backlight unit of liquid crystal display and can ensure good performance of the liquid crystal display.

### SUMMARY OF THE INVENTION

The present invention achieves the aforementioned objects by providing a light diffusion sheet comprising a light diffusion layer formed on a transparent substrate and containing a binder resin and resin particles that impart an uneven surface, wherein the resin particles are substantially spherical and have a mean particle diameter of 16.0-30.0 μm and a coefficient of variation of particle diameter distribution of less than 50.0%.

In the light diffusion sheet of the present invention, content of the resin particles is preferably 180-270 parts by weight per 100 parts by weight of the binder resin.

Further, in the light diffusion sheet of the present invention, the light diffusion layer preferably has a thickness of 25-50 μm.

The mean particle diameter and the coefficient of variation of particle diameter distribution of the resin particles used in the present invention are represented as values measured by the Coulter-counter method. The Coulter-counter method is a method of electrically measuring number and size of particles dispersed in a solution. In the Coulter-counter method, particles are dispersed in an electrolytic solution and with the aid of an attractive force are passed through a small hole through which an electric current is passed. When the particles pass through the hole, the electrolytic solution is replaced with the particles by the volume of the particles, and resistance increases. In this case, voltage pulses whose levels are proportional to the particle volumes are produced. Thus, by electrically measuring the levels and number of the pulses, the number of the particles and the volumes of individual particles can be measured to ascertain the particle diameters and particle diameter distribution.

The term “thickness” used with respect to the present invention means a value measured according to JIS-K7130, 5.1.2, Method A-2 and is an average of measured values for 5 or more measurement points.

In the light diffusion sheet of the present invention comprising a light diffusion layer formed on a transparent substrate and containing a binder resin and resin particles that impart an uneven surface, substantially spherical resin particles having a mean particle diameter of 16.0-30.0 μm and a coefficient of variation of particle diameter distribution of less than 50.0% are used as the resin particles. The light diffusion sheet therefore has high luminance in the front direction, is excellent in light-diffusing property, does not require use of an expensive prism sheet which , is readily susceptible to surface damage, and does not require careful handling.

Moreover, when a backlight unit of a liquid crystal display is produced by using the light diffusion sheet of the present invention, the uneven surface of the light diffusion layer is not readily susceptible to damage during handling. The light diffusion sheet can easily be handled even if it is large in size, and, therefore, it is extremely effective for the production of the large liquid crystal displays currently in use.

### BRIEF EXPLANATION OF DRAWINGS

FIG. 1 shows a sectional view of an exemplary light diffusion sheet according to the present invention, FIG. 2 shows a sectional view of an exemplary application of a light diffusion sheet according to the present invention used in combination with a backlight unit, and FIG. 3 shows a sectional view of another exemplary application of a light diffusion sheet according to the present invention used in combination with a backlight unit.

### PREFERRED EMBODIMENTS OF THE INVENTION

Embodiments of the light diffusion sheet of the present invention will now be explained in detail with reference to the drawings.

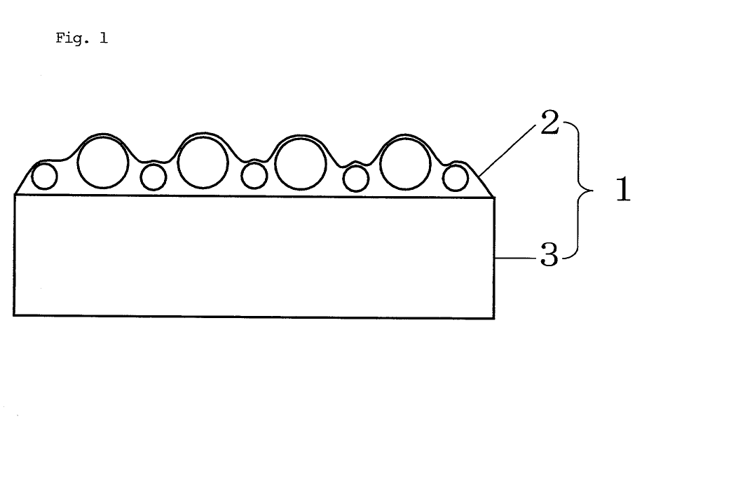

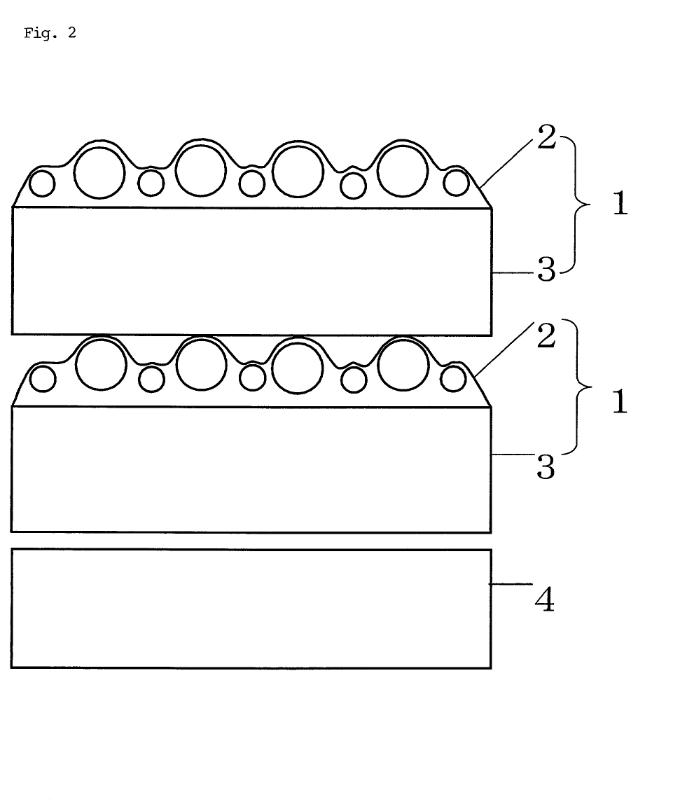

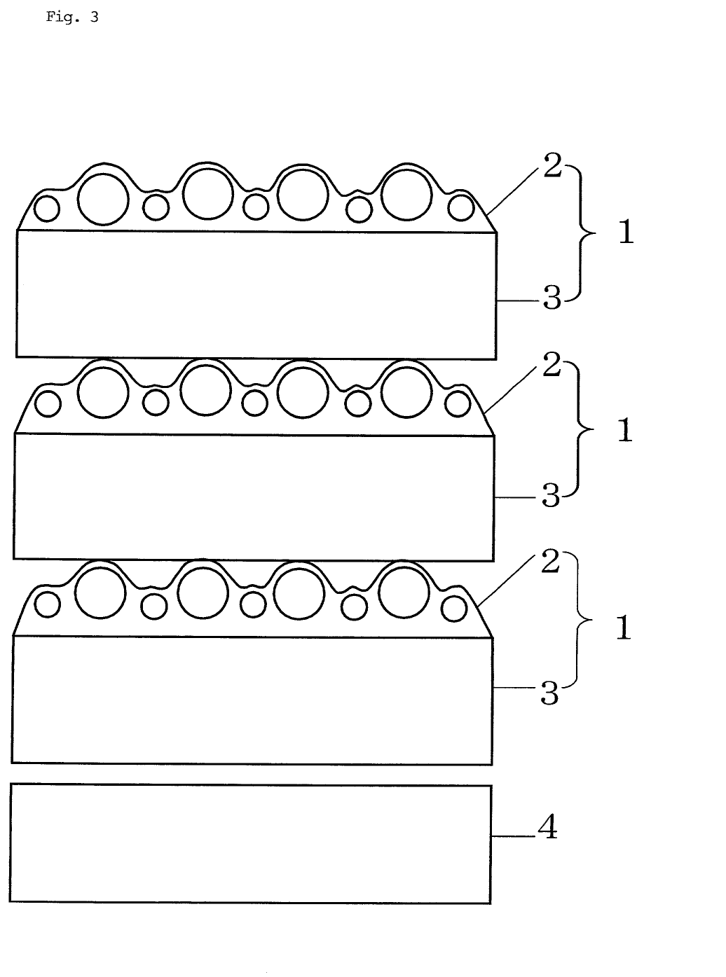

As shown in FIG. 1, the light diffusion sheet 1 of the present invention comprises a light diffusion layer 2 containing a binder resin and resin particles that impart an uneven surface, which layer is formed on a transparent substrate 3. The resin particles contained in the light diffusion layer 2 are substantially spherical and have an average particle diameter of 16.0-30.0 μm and a coefficient of variation of particle diameter distribution of less than 50.0%. By using such resin particles, luminance in the front direction can be increased while securing excellent light-diffusing property. In addition, the uneven surface of the light diffusion layer 2 can be made resistant to damage during handling of the sheet.

To obtain luminance of the degree required for use of the light diffusion sheet 1 of the present invention in a backlight unit of a liquid crystal display, the light diffusion sheet 1 preferably has high total light transmission. The total light transmission is preferably 70.0% or more, more preferably 75.0% or more. Further, to obtain light-diffusing property of the degree required for use in a backlight unit of a liquid crystal display, the light diffusion sheet 1 also preferably has high haze. The haze is preferably 80.0% or more, more preferably 85.0% or more.

The total light transmission and haze mentioned above preferably fall within the above defined ranges as values measured by directing light onto the surface of the light diffusion sheet 1 opposite to the surface having the light diffusion layer 2 (this surface is referred to simply as the “back surface” in contrast to the surface having the light diffusion layer 2).

In the present invention, the total light transmission and haze are those defined in JIS-K7105, and they satisfy the following relationship: Td (%)/Tt (%)×100 (%)=H (%) [Td: diffused light transmission, Tt: total light transmission, H: haze].

The light diffusion sheet 1 of the present invention can be obtained by, for example, preparing a resin solution for forming a light diffusion layer comprising a binder resin and resin particles dispersed or dissolved in a solvent, applying the resin solution to a transparent support 3 by a conventional application method, and drying the solution to form a laminated film.

Examples of the binder resin usable for the light diffusion layer 2 include optically transparent thermoplastic resins, thermosetting resins, ionizing radiation hardening resins and so forth, such as polyester resins, acrylic resins, polyester acrylate resins, polyurethane acrylate resins, epoxy acrylate resins, cellulose resins, acetal resins, vinyl resins, polyethylene resins, polystyrene resins, polypropylene resins, polyamide resins, polyimide resins, melamine resins, phenol resins, silicone resins and fluorocarbon resins.

Among these resins, acrylic resins exhibiting weather resistance and high transparency are preferred, and two-pack type polyurethane acrylate resins are particularly preferred. Further, those having a high OH value, which provides high crosslinking density, are desirably used so that a tough coated film can be obtained even when a large amount of resin particles are contained.

As the resin particles, those having a substantially spherical shape and a mean particle diameter of 16.0-30.0 μm, preferably 18.0-28.0 μm, are used. If the mean particle diameter is less than 16.0 μm, the damage resistance of the uneven surface of the light diffusion layer 2, a key feature of the present invention, cannot be obtained. Further, if it exceeds 30.0 μm, it becomes difficult to prepare and/or coat the resin solution for forming the light diffusion layer, and thus becomes difficult to obtain the high luminance and excellent light diffusion that are features of the present invention.

The resin particles also have a coefficient of variation of particle diameter distribution of less than 50.0%, preferably 45.0% or less. The coefficient of variation of particle diameter distribution is a value representing variation of the particle diameter distribution (degree of distribution). A larger coefficient of variation represents larger distribution. The coefficient of variation is represented as a percentage obtained by dividing the standard deviation of particle diameter distribution (square root of unbiased variance) by the arithmetic mean value of particle diameter (mean particle diameter) and multiplying the result by 100. If the coefficient of variation of particle diameter distribution is 50.0% or more, it becomes difficult to obtain the high luminance and excellent light diffusion that are features of the present invention. Further, the coefficient of variation is preferably 20.0% or more, more preferably 25.0% or more.

Examples of such resin particles as described above include acrylic resin particles, silicone resin particles, nylon resin particles, styrene resin particles, polyethylene resin particles, benzoguanamine resins particle, urethane resin particles and so forth.

The content of the resin particles cannot be absolutely defined, since it depends on the mean particle diameter of the resin particles and/or the thickness of the light diffusion layer 2 to be used. Generally speaking, however, the content is preferably 180-270 parts by weight, more preferably 200-250 parts by weight, with respect to 100 parts by weight of the binder resin. If the content is less than 180 parts by weight, it is difficult to obtain high resistance to damage of the uneven surface when resin particles of a relatively small mean particle diameter are used. If the content exceeds 270 parts by weight, the strength of the coated film is lowered and the uneven surface of the light diffusion layer 2 may become susceptible to damage.

Although the thickness of the light diffusion layer 2 also varies depending on the mean particle diameter of the resin particles used and/or their content relative to the binder resin, it is preferably 25.0-50.0 μm, more preferably 30.0-40.0 μm.

When the thickness is in the range of 25.0-50.0 μm, the resin particles of a mean particle diameter in the above-defined range can be maintained in the light diffusion layer in a good state, and excellent luminance and light diffusion properties can easily be obtained.

As the transparent support 3 on which the light diffusion layer is formed, there can be used transparent plastic films, such as polyethylene films, polypropylene films, polyethylene terephthalate films, polycarbonate films and polymethyl methacrylate films. Among them, polyethylene terephthalate films are preferably used in view of weather resistance and processability.

The light diffusion sheet 1 of the present invention is preferably provided with an anti-Newton ring layer or other means for preventing Newton rings caused by close contact of the back surface of the sheet with the light conductive panel or the like. A suitable anti-Newton ring layer can be obtained by applying a coat of a binder resin containing particles having a mean particle diameter of about 10 μm in an amount of about 5 parts by weight with respect to 100 parts by weight of the binder resin to form a layer having a thickness of about 8-12 μm.

### EXAMPLES

Examples of the present invention will be explained hereafter. “Part” and “%” are used on a weight basis unless otherwise indicated.

### Example 1

A light diffusion sheet 1 of the structure shown in FIG. 1 was produced by applying a resin solution for light diffusion layer (a) having the following composition on one surface of a polyethylene terephthalate film 3 of a thickness of 100 μm (LumirrorT-60, Toray Industries, Inc.) and drying the solution to form a light diffusion layer 2 of a thickness of about 33 μm.

<Resin solution for light diffusion layer (a)>

| | |
|---|---|
| Acryl polyol (solid content: 50%, Acrydic A-807, Dainippon | 162 parts |
| Ink & Chemicals, Inc.) | |
| Isocyanate (solid content: 60%, Takenate D110N, Takeda | 32 parts |
| Chemical Industries, Ltd.) | |
| Polymethyl methacrylate resin particles (mean particle | 220 parts |
| diameter: 18.2 μm, coefficient of variation: 31.6%) | |
| Butyl acetate | 215 parts |
| Methyl ethyl ketone | 215 parts |

### Example 2

A light diffusion sheet 1 of the structure shown in FIG. 1 was produced by applying a resin solution for light diffusion layer (b) having the following composition on one surface of a polyethylene terephthalate film 3 of a thickness of 100 μm (Lumirror T-60, Toray Industries, Inc.) and drying the solution to form a light diffusion layer 2 of a thickness of about 40 μm.

<Resin solution for light diffusion layer (b)>

| | |
|---|---|
| Acryl polyol (solid content: 50%, Acrydic A-807, Dainippon | 162 parts |
| Ink & Chemicals, Inc.) | |
| Isocyanate (solid content: 60%, Takenate D110N, Takeda | 32 parts |
| Chemical Industries, Ltd.) | |
| Polymethyl methacrylate resin particles (mean particle | 250 parts |
| diameter: 27.3 μm, coefficient of variation: 42.5%) | |
| Butyl acetate | 215 parts |
| Methyl ethyl ketone | 215 parts |

### Example 3

A light diffusion sheet 1 of the structure shown in FIG. 1 was produced by applying a resin solution for light diffusion layer (c) having the following composition on one surface of a polyethylene terephthalate film 3 of a thickness of 100 μm (Lumirror T-60, Toray Industries, Inc.) and drying the solution to form a light diffusion layer 2 of a thickness of about 27 μm.

<Resin solution for light diffusion layer (c)>

| | |
|---|---|
| Acryl polyol (solid content: 50%, Acrydic A-807, Dainippon | 162 parts |
| Ink & Chemicals, Inc.) | |
| Isocyanate (solid content: 60%, Takenate D110N, Takeda | 32 parts |
| Chemical Industries, Ltd.) | |
| Polymethyl methacrylate resin particles (mean particle | 200 parts |
| diameter: 22.1 μm, coefficient of variation: 21.1%) | |
| Butyl acetate | 215 parts |
| Methyl ethyl ketone | 215 parts |

### Comparative Example 1

A light diffusion sheet 1 of the structure shown in FIG. 1 was produced by applying a resin solution for light diffusion layer (d) having the following composition on one surface of a polyethylene terephthalate film 3 of a thickness of 100 μm (Lumirror T-60, Toray Industries, Inc.) and drying the solution to form a light diffusion layer 2 of a thickness of about 12 μm.

<Resin solution for light diffusion layer (d)>

| | |
|---|---|
| Acryl polyol (solid content: 50%, Acrydic A-807, Dainippon | 162 parts |
| Ink & Chemicals, Inc.) | |
| Isocyanate (solid content: 60%, Takenate D110N, Takeda | 32 parts |
| Chemical Industries, Ltd.) | |
| Polymethyl methacrylate resin particles (mean particle | 160 parts |
| diameter: 8.6 μm, coefficient of variation: 36.8%) | |
| Butyl acetate | 215 parts |
| Methyl ethyl ketone | 215 parts |

### Comparative Example 2

A light diffusion sheet 1 of the structure shown in FIG. 1 was produced by applying a resin solution for light diffusion layer (e) having the following composition on one surface of a polyethylene terephthalate film 3 of a thickness of 100 μm (Lumirror T-60, Toray Industries, Inc.) and drying the solution to form a light diffusion layer 2 of a thickness of about 12 μm.

<Resin solution for light diffusion layer (e)>

| | |
|---|---|
| Acryl polyol (solid content: 50%, Acrydic A-807, Dainippon | 162 parts |
| Ink & Chemicals, Inc.) | |
| Isocyanate (solid content: 60%, Takenate D110N, Takeda | 32 parts |
| Chemical Industries, Ltd.) | |
| Polystyrene resin particles (mean particle diameter: 8.9 μm, | 220 parts |
| coefficient of variation: 37.0%) | |
| Butyl acetate | 215 parts |
| Methyl ethyl ketone | 215 parts |

### Comparative Example 3

A light diffusion sheet 1 of the structure shown in FIG. 1 was produced by applying a resin solution for light diffusion layer (f) having the following composition on one surface of a polyethylene terephthalate film 3 of a thickness of 100 μm (Lumirror T-60, Toray Industries, Inc.), drying the solution, and irradiating the applied layer with an UV ray from a high pressure mercury lamp for 1 or 2 seconds to form a light diffusion layer 2 of a thickness of about 6 μm.

<Resin solution for light diffusion layer (f)>

| | | |
|---|---|---|
| Ionizing radiation curable acrylic resin (solid content: 50%, | 100 | parts |
| Unidic 17-813, Dainippon Ink & Chemicals, Inc.) | | |
| Photopolymerization initiator (Irgacure, Ciba Specialty | 1 | part |
| Chemicals K.K.) | | |
| Polymethyl methacrylate resin particles (mean particle | 1.6 | parts |
| diameter: 5.8 μm, coefficient of variation: 7.8%) | | |
| Propylene glycol monomethyl ether | 200 | parts |

The light diffusion sheets 1 obtained in Examples 1-3 and Comparative Examples 1-3 as described above were evaluated for improvement in luminance and light-diffusing property. The optical characteristics, i.e., total light transmission and haze, of the light diffusion sheets 1 were also measured.

### Evaluation of Improvement in Luminance

Two (FIG. 2) or three (FIG. 3) of the light diffusion sheets 1 of Examples 1-3 and Comparative Examples 1-3 were built into a backlight unit 4 for 5.8-inch liquid crystal display (comprising one of U-shaped lamp and a light conductive plate of a thickness of 5 mm) so that the transparent supports 3 of the light diffusion sheets 1 faced the light conductive plate, and luminance was measured from the front direction. Separately, luminance of the backlight unit itself was measured from the front direction. Thus, improvement in luminance obtained by incorporating the light diffusion sheets was evaluated.

Specifically, luminance improvement values were calculated in accordance with the following equation.

[Luminance from front direction measured with light diffusion sheet (cd/m²)]−[Luminance from front direction measured for backlight unit itself (without light diffusion sheet) (cd/m²)]=[Luminance improvement value (cd/m²)]

The results are shown in Table 1.

### Evaluation of Light-diffusing Property

In the evaluation of the luminance improvement, invisibility of light diffusion pattern of the light conduction plates was simultaneously evaluated by visual inspection. The results are indicated by ″ when the light diffusion pattern could not be observed, and with “x” when the light diffusion pattern could be observed. The evaluation results are shown in Table 1.

### Resistance to Damage of Uneven Surface of Light Diffusion Layer

Uneven surfaces of the light diffusion layers 2 of the light diffusion sheets 1 obtained in Examples 1-3 and Comparative Examples 1-3 were evaluated as follows using a surface measurement apparatus (HEIDON-14, ShintoScienticCo., Ltd.). Two light diffusion sheets 1 of each type were prepared. The uneven surfaces of the light diffusion layers 2 were brought in contact at a pressure of 1 kPa and slid across each other at a speed of 5 m/min. The damage to the uneven surfaces of the light diffusion layers 2 was then examined. The results were indicated by ″ when no change in appearance of the uneven surfaces was observed, by “Δ” when one to nine streaks were observed, and by “x” when ten or more streaks were observed. The evaluation results are shown in Table 2.

### Measurement of Total Light Transmission and Haze of Light Diffusion Sheet

Total light transmission and haze of the light diffusion sheets 1 obtained in Examples 1-3 and Comparative Examples 1-3 were measured using a haze meter (HGM-2K: Suga Test Instruments Co., Ltd.). The total light transmission and haze were measured by applying light from the back surfaces of the light diffusion sheets 1. The measurement results are shown in Table 1.

TABLE 1

| | | | | Comparative | Comparative | Comparative |
|---|---|---|---|---|---|---|
| | Example 1 | Example 2 | Example 3 | Example 1 | Example 2 | Example 3 |
| Light-difusing property | ◯ | ◯ | ◯ | ◯ | ◯ | X |
| Two of light diffusion sheets | | | | | | |
| were incorporated on light | | | | | | |
| conduction plate of back light | | | | | | |
| unit | | | | | | |
| Front luminance | 4690 | 4950 | 4940 | 4690 | 4810 | 2770 |
| (cd/m²) | | | | | | |
| Luminance | 2720 | 2710 | 2700 | 2450 | 2570 | 530 |
| improvement value | | | | | | |
| (cd/m²) | | | | | | |
| Three of light diffusion sheets | | | | | | |
| were incorporated on light | | | | | | |
| conduction plate of back light | | | | | | |
| unit | | | | | | |
| Front luminance | 5340 | 5280 | 5260 | 5130 | 4930 | 2900 |
| (cd/m²) | | | | | | |
| Luminance | 3100 | 3040 | 3020 | 2890 | 2690 | 660 |
| improvement value | | | | | | |
| (cd/m²) | | | | | | |
| Front luminance of back light itself (cd/m²) | 2240 | | | | | |
| Total light transmission (%) | 75.8 | 73.0 | 75.7 | 81.5 | 75.6 | 90.6 |
| Haze (%) | 87.4 | 85.1 | 85.0 | 89.3 | 91.1 | 29.0 |

TABLE 2

| | | | | Comparative | Comparative | Comparative |
|---|---|---|---|---|---|---|
| | Example 1 | Example 2 | Example 3 | Example 1 | Example 2 | Example 3 |
| Resistance to damage | ∘ | ∘ | ∘ | X | X | Δ |
| of uneven surface of | | | | | | |
| light diffusion layer | | | | | | |
| Mean particle | 18.2 | 27.3 | 22.1 | 8.6 | 8.9 | 5.8 |
| diameter (μm) | | | | | | |
| Coefficient of | 31.6 | 42.5 | 21.1 | 36.8 | 37.0 | 7.8 |
| variation (%) | | | | | | |
| Film thickness | 33 | 40 | 27 | 12 | 12 | 6 |
| (μm) | | | | | | |
| Binder resin | Thermosetting | Thermosetting | Thermosetting | Thermosetting | Thermosetting | Ionizing |
| | acrylic resin | acrylic resin | acrylic resin | acrylic resin | acrylic resin | radiation |
| | | | | | acrylic resin | curable |
| | | | | | | acrylic resin |
| Resin particles | Polymethyl | Polymethyl | Polymethyl | Polymethyl | Polystyrene | Polymethyl |
| | methacrylate resin | methacrylate resin | methacrylate resin | methacrylate resin | resin | methacrylate |
| | | | | | | resin |

As seen from the results shown in Tables 1 and 2, the light diffusion sheets 1 of Examples 1-3 showed good luminance and light-diffusing properties, and further showed very superior resistance to damage of the uneven surfaces of the light diffusion layers 2, because they used resin particles having an average particle diameter of 16.0-30.0 μm and a coefficient of variation of particle diameter distribution of less than 50.0%.

In contrast, the light diffusion sheets 1 of Comparative Examples 1-3 were inferior in luminance and resistance to damage of the uneven surfaces of the light diffusion layers 2, because the mean particle diameter of the resin particles was less than 16.0 μm.

What is claimed is:

1. A light diffusion sheet comprising a light diffusion layer formed on a transparent substrate and containing a binder resin and resin particles that impart an uneven surface, wherein the resin particles are substantially spherical and have a mean particle diameter of 16.0-30.0 μm and a coefficient of variation of particle diameter distribution of less than 50.0%.

2. The light diffusion sheet according to claim 1, wherein content of the resin particles is 180-270 parts by weight per 100 parts by weight of the binder resin.

3. The light diffusion sheet according to claim 1, wherein the light diffusion layer has a thickness of 25-50 μm.

4. The light diffusion sheet according to claim 1, wherein the binder resin is a thermosetting acrylic resin.
